(19) United States
(12) Patent Application Publication
(10) Pub. No.: US 2023/0027298 A1
(43) Pub. Date: Jan. 26, 2023

(54) Methods of Hydroarylation with Acid Catalysts

(71) Applicant: The Regents Of The University Of California, Oakland, CA (US)

(72) Inventors: Benjamin J. Stokes, Mountain View, CA (US); Jose M. Alvarenga, Los Angeles, CA (US); Amir Keshavarz, Winnetka, CA (US); Xiao Cai, Dublin, CA (US)

(21) Appl. No.: 17/783,602

(22) PCT Filed: Dec. 7, 2020
(86) PCT No.: PCT/US2020/063625

§ 371 Date: Jun. 8, 2022

Related U.S. Application Data
(60) Provisional application No. 62/947,044, filed on Dec. 12, 2019.

(51) Int. Cl. B01J 31/02; B01J 31/04; B01J 31/14

(52) U.S. Cl. CPC B01J 31/0247; B01J 31/0224; B01J 31/0227; B01J 31/0271; B01J 31/0274; B01J 31/04; B01J 31/146; B01J 2231/323; B01J 2231/4205; B01J 2531/0297; B01J 2540/22; B01J 2540/62

(57) ABSTRACT

Provided are methods of forming a carbon-carbon bond between a first compound and a second compound through a hydroarylation chemical reaction. The methods include contacting the first compound and the second compound in the presence of an acid catalyst. The methods include forming a carbon-carbon bond wherein the first compound includes a first aryl group that is electron-deficient. Provided is a method of generating a quaternary carbon through a hydroarylation chemical reaction.

### CROSS-REFERENCE TO RELATED APPLICATIONS

This application claims the benefit of U.S. Provisional Application No. 62/947,044, filed Dec. 12, 2019, the disclosure of which is incorporated herein by reference.

### INTRODUCTION

Methods of forming carbon-carbon bonds are of central importance in the art of organic chemistry, and to arts that are related to or depend upon organic chemistry. Numerous pharmaceutical compounds, industrial chemicals, agricultural chemicals, and other fine chemicals can only be produced by methods involving carbon-carbon bond formation. In other cases, carbon-carbon bond formation renders the chemical syntheses of such compounds more simple, economical, or safe compared to methods that lack a carbon-carbon bond forming step.

Hydroarylation is a type of carbon-carbon bond forming method that involves the reaction of a carbon-carbon double bond containing compound with a second compound including an aryl-hydrogen bond. Hydroarylation can be interpreted as the formal addition of the aryl-hydrogen bond across the carbon-carbon double bond, resulting in a new carbon-carbon bond.

### SUMMARY

Provided are methods of forming a carbon-carbon bond between a first compound and a second compound through a hydroarylation chemical reaction. The methods include contacting the first compound and the second compound in the presence of an acid catalyst. The methods include forming a carbon-carbon bond wherein the first compound includes a first aryl group that is electron-deficient. Provided is a method of generating a quaternary carbon through a hydroarylation chemical reaction.

### BRIEF DESCRIPTION OF THE FIGURES

FIG. 1 shows the effect of catalyst identity and mole ratios on the yield of a hydroarylation product and a dimerization product.

FIG. 2A shows a substrate scope of the reaction with para-trifluoromethyl substituted arenes.

FIG. 2B shows an additional substrate scope of the reaction with para-trifluoromethyl substituted arenes.

FIG. 3 shows a substrate scope of the reaction with meta-trifluoromethyl substituted arenes.

FIG. 4 shows a substrate scope of the reaction with ortho-trifluoromethyl substituted arenes.

FIG. 5 shows the effect of solvent identity on the hydroarylation and dimerization reactions.

FIG. 6 shows a substrate scope with compounds having a methyl substituent on a vinylic carbon.

### DEFINITIONS

Many general references providing commonly known chemical synthetic schemes and conditions useful for synthesizing the disclosed compounds are available (see, e.g., Smith and March, March's Advanced Organic Chemistry: Reactions, Mechanisms, and Structure, Fifth Edition, Wiley-Interscience, 2001; or Vogel, A Textbook of Practical Organic Chemistry, Including Qualitative Organic Analysis, Fourth Edition, New York: Longman, 1978).

Where compounds described herein contain one or more chiral centers and/or double-bond isomers (i.e., geometric isomers), enantiomers or diastereomers, all possible enantiomers and stereoisomers of the compounds including the stereoisomerically pure form (e.g., geometrically pure, enantiomerically pure or diastereomerically pure) and enantiomeric and stereoisomeric mixtures are included in the description of the compounds herein. Enantiomeric and stereoisomeric mixtures can be resolved into their component enantiomers or stereoisomers using separation techniques or chiral synthesis techniques well known to the skilled artisan. The compounds can also exist in several tautomeric forms including the enol form, the keto form and mixtures thereof. Accordingly, the chemical structures depicted herein encompass all possible tautomeric forms of the illustrated compounds. The compounds described also include isotopically labeled compounds where one or more atoms have an atomic mass different from the atomic mass conventionally found in nature. Examples of isotopes that can be incorporated into the compounds disclosed herein include, but are not limited to, ²H, ³H, ¹¹C, ¹³C, ¹⁴C, ¹⁵N, ¹⁸O, ¹⁷O, etc. Compounds can exist in unsolvated forms as well as solvated forms, including hydrated forms. In general, compounds can be hydrated or solvated. Certain compounds can exist in multiple crystalline or amorphous forms. In general, all physical forms are equivalent for the uses contemplated herein and are intended to be within the scope of the present disclosure.

The term “catalyst” refers to a category of compounds that includes precatalyts and active catalysts. An “active catalyst” is a compound that catalyzes a chemical reaction and is part of the catalytic cycle. A precatalyst is a compound that is not part of the catalytic cycle, but which is converted to an active catalyst under reaction conditions.

The term “acid catalyst” includes Brønsted acids and salts of Brønsted acids. The term “Brønsted acid salt catalyst” refers to an acid catalyst that is a salt of a Brønsted acid. The term “non-coordinating ionic acid catalyst” refers to a Brønsted acid salt catalyst that includes a non-coordinating cation and a non-coordinating anion.

The terms “triphenylmethyl”, “trityl”, and “[Ph₃C]+” are used interchangeably herein.

The terms “dative bond” and “coordination bond” are used interchangeably herein.

The term “alkyl” as used herein refers to a branched or unbranched saturated hydrocarbon group (i.e., a mono-radical) typically although not necessarily containing 1 to about 24 carbon atoms, such as methyl, ethyl, n-propyl, isopropyl, n-butyl, isobutyl, t-butyl, octyl, decyl, and the like, as well as cycloalkyl groups such as cyclopentyl, cyclohexyl and the like. Generally, although not necessarily, alkyl groups herein may contain 1 to about 18 carbon atoms, and such groups may contain 1 to about 12 carbon atoms. The term “lower alkyl” intends an alkyl group of 1 to 6 carbon atoms. “Substituted alkyl” refers to alkyl substituted with one or more substituent groups, and this includes instances wherein two hydrogen atoms from the same carbon atom in an alkyl substituent are replaced, such as in a carbonyl group (i.e., a substituted alkyl group may include a —C(═O)— moiety). If not otherwise indicated, the terms “alkyl” and “lower alkyl” include linear, branched, cyclic, unsubstituted, substituted, and/or heteroatom-containing alkyl or lower alkyl, respectively.

The term “alkyl” includes both homoalkyls and heteroalkyls. Homoalkyl is a alkyl that is not a heteroalkyl. The terms “heteroatom-containing alkyl” and “heteroalkyl” refer to an alkyl substituent in which at least one carbon atom is replaced with a heteroatom.

Examples of heteroalkyls include ethylenediamine (i.e. ethane-1,2-diamine) and diethyl ether (i.e. ethoxyethane). The term “homoalkyl” refers to an alkyl substituent in which no carbon atom has been replaced with a heteroatom. Examples of homoalkyls include n-octane, cyclooctane, and isobutane (i.e. 2-methylpropoane).

The term “substituted alkyl” refers to an alkyl group as defined herein wherein one or more carbon atoms in the alkyl chain (other than the C₁ carbon) have been optionally replaced with a heteroatom such as —O—, —N—, —S—, —S(O)ₙ— (where n is 0 to 2), —NR— (where R is hydrogen or alkyl) and having from 1 to 5 substituents selected from the group consisting of alkoxy, substituted alkoxy, cycloalkyl, substituted cycloalkyl, cycloalkenyl, substituted cycloalkenyl, acyl, acylamino, acyloxy, amino, aminoacyl, aminoacyloxy, oxyaminoacyl, azido, cyano, halogen, hydroxyl, oxo, thioketo, carboxyl, carboxylalkyl, thioaryloxy, thioheteroaryloxy, thioheterocyclooxy, thiol, thioalkoxy, substituted thioalkoxy, aryl, aryloxy, heteroaryl, heteroaryloxy, heterocyclyl, heterocyclooxy, hydroxyamino, alkoxyamino, nitro, —SO-alkyl, —SO-aryl, —SO-heteroaryl, —SO₂-alkyl, —SO₂-aryl, —SO₂-heteroaryl, and —NR^{a}R^{b}, wherein R′ and R″ may be the same or different and are chosen from hydrogen, optionally substituted alkyl, cycloalkyl, alkenyl, cycloalkenyl, alkynyl, aryl, heteroaryl and heterocyclic.

The term “alkenyl” as used herein refers to a linear, branched or cyclic hydrocarbon group of 2 to about 24 carbon atoms containing at least one double bond, such as ethenyl, n-propenyl, isopropenyl, n-butenyl, isobutenyl, octenyl, decenyl, tetradecenyl, hexadecenyl, eicosenyl, tetracosenyl, and the like. Generally, although again not necessarily, alkenyl groups herein may contain 2 to about 18 carbon atoms, and for example may contain 2 to 12 carbon atoms. The term “lower alkenyl” intends an alkenyl group of 2 to 6 carbon atoms. The term “substituted alkenyl” refers to alkenyl substituted with one or more substituent groups, and the terms “heteroatom-containing alkenyl” and “heteroalkenyl” refer to alkenyl in which at least one carbon atom is replaced with a heteroatom. If not otherwise indicated, the terms “alkenyl” and “lower alkenyl” include linear, branched, cyclic, unsubstituted, substituted, and/or heteroatom-containing alkenyl and lower alkenyl, respectively.

“Substituted alkylene” refers to an alkylene group having from 1 to 3 hydrogens replaced with substituents as described for carbons in the definition of “substituted” below.

The term “alkynyl” as used herein refers to a linear or branched hydrocarbon group of 2 to 24 carbon atoms containing at least one triple bond, such as ethynyl, n-propynyl, and the like. Generally, although again not necessarily, alkynyl groups herein may contain 2 to about 18 carbon atoms, and such groups may further contain 2 to 12 carbon atoms. The term “lower alkynyl” intends an alkynyl group of 2 to 6 carbon atoms. The term “substituted alkynyl” refers to alkynyl substituted with one or more substituent groups, and the terms “heteroatom-containing alkynyl” and “heteroalkynyl” refer to alkynyl in which at least one carbon atom is replaced with a heteroatom. If not otherwise indicated, the terms “alkynyl” and “lower alkynyl” include linear, branched, unsubstituted, substituted, and/or heteroatom-containing alkynyl and lower alkynyl, respectively.

The term “alkaryl” or “aralkyl” refers to the groups -alkylene-aryl and -substituted alkylene-aryl where alkylene, substituted alkylene and aryl are defined herein.

“Alkoxy” refers to the group —O-alkyl, wherein alkyl is as defined herein. Alkoxy includes, by way of example, methoxy, ethoxy, n-propoxy, isopropoxy, n-butoxy, t-butoxy, sec-butoxy, n-pentoxy, and the like. The term “alkoxy” also refers to the groups alkenyl-O—, cycloalkyl-O—, cycloalkenyl-O—, and alkynyl-O—, where alkenyl, cycloalkyl, cycloalkenyl, and alkynyl are as defined herein.

The term “substituted alkoxy” refers to the groups substituted alkyl-O—, substituted alkenyl-O—, substituted cycloalkyl-O—, substituted cycloalkenyl-O—, and substituted alkynyl-O— where substituted alkyl, substituted alkenyl, substituted cycloalkyl, substituted cycloalkenyl and substituted alkynyl are as defined herein.

The term “haloalkyl” refers to a substituted alkyl group as described above, wherein one or more hydrogen atoms on the alkyl group have been substituted with a halo group. Examples of such groups include, without limitation, fluoroalkyl groups, such as trifluoromethyl, difluoromethyl, trifluoroethyl and the like.

The term “alkylalkoxy” refers to the groups -alkylene-O-alkyl, alkylene-O-substituted alkyl, substituted alkylene-O-alkyl, and substituted alkylene-O-substituted alkyl wherein alkyl, substituted alkyl, alkylene and substituted alkylene are as defined herein.

“Alkenyl” refers to straight chain or branched hydrocarbyl groups having from 2 to 6 carbon atoms and preferably 2 to 4 carbon atoms and having at least 1 and preferably from 1 to 2 sites of double bond unsaturation. This term includes, by way of example, bi-vinyl, allyl, and but-3-en-1-yl. Included within this term are the cis and trans isomers or mixtures of these isomers.

The term “substituted alkenyl” refers to an alkenyl group as defined herein having from 1 to 5 substituents, or from 1 to 3 substituents, selected from alkoxy, substituted alkoxy, cycloalkyl, substituted cycloalkyl, cycloalkenyl, substituted cycloalkenyl, acyl, acylamino, acyloxy, amino, substituted amino, aminoacyl, aminoacyloxy, oxyaminoacyl, azido, cyano, halogen, hydroxyl, oxo, thioketo, carboxyl, carboxylalkyl, thioaryloxy, thioheteroaryloxy, thioheterocyclooxy, thiol, thioalkoxy, substituted thioalkoxy, aryl, aryloxy, heteroaryl, heteroaryloxy, heterocyclyl, heterocyclooxy, hydroxyamino, alkoxyamino, nitro, —SO-alkyl, —SO-substituted alkyl, —SO-aryl, —SO-heteroaryl, —SO₂-alkyl, —SO₂-substituted alkyl, —SO₂-aryl and —SO₂-heteroaryl.

“Acyl” refers to the groups H—C(O)—, alkyl-C(O)—, substituted alkyl-C(O)—, alkenyl-C(O)—, substituted alkenyl-C(O)—, alkynyl-C(O)—, substituted alkynyl-C(O)—, cycloalkyl-C(O)—, substituted cycloalkyl-C(O)—, cycloalkenyl-C(O)—, substituted cycloalkenyl-C(O)—, aryl-C(O)—, substituted aryl-C(O)—, heteroaryl-C(O)—, substituted heteroaryl-C(O)—, heterocyclyl-C(O)—, and substituted heterocyclyl-C(O)—, wherein alkyl, substituted alkyl, alkenyl, substituted alkenyl, alkynyl, substituted alkynyl, cycloalkyl, substituted cycloalkyl, cycloalkenyl, substituted cycloalkenyl, aryl, substituted aryl, heteroaryl, substituted heteroaryl, heterocyclic, and substituted heterocyclic are as defined herein. For example, acyl includes the “acetyl” group CH₃C(O)—.

“Acylamino” refers to the groups —NR²⁰C(O)alkyl, —NR²⁰C(O)substituted alkyl, NR²⁰C(O)cycloalkyl, —NR²⁰C(O)substituted cycloalkyl, —NR²⁰C(O)cycloalkenyl, —NR²⁰C(O)substituted cycloalkenyl, —NR²⁰C(O)alkenyl, —NR²⁰C(O)substituted alkenyl, —NR²⁰C(O)alkynyl, —NR²⁰C(O)substituted alkynyl, —NR²⁰C(O)aryl, —NR²⁰C(O)substituted aryl, —NR²⁰C(O)heteroaryl, —NR²⁰C(O)substituted heteroaryl, —NR²⁰C(O)heterocyclic, and —NR²⁰C(O)substituted heterocyclic, wherein R²⁰ is hydrogen or alkyl and wherein alkyl, substituted alkyl, alkenyl, substituted alkenyl, alkynyl, substituted alkynyl, cycloalkyl, substituted cycloalkyl, cycloalkenyl, substituted cycloalkenyl, aryl, substituted aryl, heteroaryl, substituted heteroaryl, heterocyclic, and substituted heterocyclic are as defined herein.

“Aminocarbonyl” or the term “aminoacyl” refers to the group —C(O)NR²¹R²², wherein R²¹ and R²² independently are selected from the group consisting of hydrogen, alkyl, substituted alkyl, alkenyl, substituted alkenyl, alkynyl, substituted alkynyl, aryl, substituted aryl, cycloalkyl, substituted cycloalkyl, cycloalkenyl, substituted cycloalkenyl, heteroaryl, substituted heteroaryl, heterocyclic, and substituted heterocyclic and where R²¹ and R²² are optionally joined together with the nitrogen bound thereto to form a heterocyclic or substituted heterocyclic group, and wherein alkyl, substituted alkyl, alkenyl, substituted alkenyl, alkynyl, substituted alkynyl, cycloalkyl, substituted cycloalkyl, cycloalkenyl, substituted cycloalkenyl, aryl, substituted aryl, heteroaryl, substituted heteroaryl, heterocyclic, and substituted heterocyclic are as defined herein.

“Aminocarbonylamino” refers to the group —NR²¹C(O)NR²²R²³ where R²¹, R²², and R²³ are independently selected from hydrogen, alkyl, aryl or cycloalkyl, or where two R groups are joined to form a heterocyclyl group.

The term “alkoxycarbonylamino” refers to the group —NRC(O)OR where each R is independently hydrogen, alkyl, substituted alkyl, aryl, heteroaryl, or heterocyclyl wherein alkyl, substituted alkyl, aryl, heteroaryl, and heterocyclyl are as defined herein.

The term “acyloxy” refers to the groups alkyl-C(O)O—, substituted alkyl-C(O)O—, cycloalkyl-C(O)O—, substituted cycloalkyl-C(O)O—, aryl-C(O)O—, heteroaryl-C(O)O—, and heterocyclyl-C(O)O— wherein alkyl, substituted alkyl, cycloalkyl, substituted cycloalkyl, aryl, heteroaryl, and heterocyclyl are as defined herein.

The term “aryl” as used herein, and unless otherwise specified, refers to an aromatic substituent generally, although not necessarily, containing 5 to 30 carbon atoms and containing a single aromatic ring or multiple aromatic rings that are fused together, directly linked, or indirectly linked (such that the different aromatic rings are bound to a common group such as a methylene or ethylene moiety). Aryl groups may, for example, contain 5 to 20 carbon atoms, and as a further example, aryl groups may contain 5 to 12 carbon atoms. For example, aryl groups may contain one aromatic ring or two or more fused or linked aromatic rings (i.e., biaryl, aryl-substituted aryl, etc.). Examples include phenyl, naphthyl, biphenyl, diphenylether, diphenylamine, benzophenone, and the like.

Aryl is intended to include stable cyclic, heterocyclic, polycyclic, and polyheterocyclic unsaturated C₃-C₁₄ moieties, exemplified but not limited to phenyl, biphenyl, naphthyl, pyridyl, furyl, thiophenyl, imidazoyl, pyrimidinyl, and oxazoyl; which may further be substituted with one to five members selected from the group consisting of hydroxy, C₁-C₈ alkoxy, C₁-C₈ branched or straight-chain alkyl, acyloxy, carbamoyl, amino, N-acylamino, nitro, halogen, trifluoromethyl, cyano, and carboxyl (see e.g. Katritzky, Handbook of Heterocyclic Chemistry). If not otherwise indicated, the term “aryl” includes unsubstituted, substituted, and/or heteroatom-containing aromatic substituents.

The term “aryl” includes both homoaryls and heteroaryls. The term “heteroaryl” is described below. A “homoaryl” is an aryl that is not a heteroaryl.

“Substituted aryl” refers to an aryl moiety substituted with one or more substituent groups.

The term “aralkyl” refers to an alkyl group with an aryl substituent, and the term “alkaryl” refers to an aryl group with an alkyl substituent, wherein “alkyl” and “aryl” are as defined above. In general, aralkyl and alkaryl groups herein contain 6 to 30 carbon atoms.

Aralkyl and alkaryl groups may, for example, contain 6 to 20 carbon atoms, and as a further example, such groups may contain 6 to 12 carbon atoms.

“Aryloxy” refers to the group —O-aryl, wherein aryl is as defined herein, including, by way of example, phenoxy, naphthoxy, and the like, including optionally substituted aryl groups as also defined herein.

“Amino” refers to the group —NH₂.

The term “substituted amino” refers to the group —NRR where each R is independently selected from the group consisting of hydrogen, alkyl, substituted alkyl, cycloalkyl, substituted cycloalkyl, alkenyl, substituted alkenyl, cycloalkenyl, substituted cycloalkenyl, alkynyl, substituted alkynyl, aryl, heteroaryl, and heterocyclyl provided that at least one R is not hydrogen.

The term “azido” or “azide” refers to the group —Ns.

“Carboxyl,” “carboxy” or “carboxylate” refers to —CO₂H or salts thereof.

“Carboxyl ester” or “carboxy ester” or the terms “carboxyalkyl” or “carboxylalkyl” refers to the groups —C(O)O-alkyl, —C(O)O-substituted alkyl, —C(O)O-alkenyl, —C(O)O-substituted alkenyl, —C(O)O-alkynyl, —C(O)O-substituted alkynyl, —C(O)O-aryl, —C(O)O-substituted aryl, —C(O)O-cycloalkyl, —C(O)O-substituted cycloalkyl, —C(O)O-cycloalkenyl, —C(O)O-substituted cycloalkenyl, —C(O)O-heteroaryl, —C(O)O-substituted heteroaryl, —C(O)O-heterocyclic, and —C(O)O-substituted heterocyclic, wherein alkyl, substituted alkyl, alkenyl, substituted alkenyl, alkynyl, substituted alkynyl, cycloalkyl, substituted cycloalkyl, cycloalkenyl, substituted cycloalkenyl, aryl, substituted aryl, heteroaryl, substituted heteroaryl, heterocyclic, and substituted heterocyclic are as defined herein.

“(Carboxyl ester)oxy” or “carbonate” refers to the groups —O—C(O)O— alkyl, —O—C(O)O-substituted alkyl, —O—C(O)O-alkenyl, —O—C(O)O-substituted alkenyl, —O—C(O)O-alkynyl, —O—C(O)O-substituted alkynyl, —O—C(O)O-aryl, —O—C(O)O-substituted aryl, —O—C(O)O-cycloalkyl, —O—C(O)O-substituted cycloalkyl, —O—C(O)O-cycloalkenyl, —O—C(O)O-substituted cycloalkenyl, —O—C(O)O-heteroaryl, —O—C(O)O-substituted heteroaryl, —O—C(O)O-heterocyclic, and —O—C(O)O-substituted heterocyclic, wherein alkyl, substituted alkyl, alkenyl, substituted alkenyl, alkynyl, substituted alkynyl, cycloalkyl, substituted cycloalkyl, cycloalkenyl, substituted cycloalkenyl, aryl, substituted aryl, heteroaryl, substituted heteroaryl, heterocyclic, and substituted heterocyclic are as defined herein.

“Cyano” or “nitrile” refers to the group —CN.

As used herein, “carbocycle” or “carbocyclic ring” is intended to mean any stable monocyclic, bicyclic, or tricyclic ring having the specified number of carbons, any of which may be saturated, unsaturated, or aromatic. For example, a C3-14 carbocycle is intended to mean a mono-, bi-, or tricyclic ring having 3, 4, 5, 6, 7, 8, 9, 10, 11, 12, 13, or 14 carbon atoms. Examples of carbocycles include, but are not limited to, cyclopropyl, cyclobutyl, cyclobutenyl, cyclopentyl, cyclopentenyl, cyclohexyl, cycloheptenyl, cycloheptyl, cycloheptenyl, adamantyl, cyclooctyl, cyclooctenyl, cyclooctadienyl, fluorenyl, phenyl, naphthyl, indanyl, adamantyl, and tetrahydronaphthyl. Bridged rings are also included in the definition of carbocycle, including, for example, [3.3.0]bicyclooctane, [4.3.0]bicyclononane, [4.4.0]bicyclodecane, and [2.2.2]bicyclooctane. A bridged ring occurs when a covalent bond or one or more carbon atoms link two non-adjacent carbon atoms in a ring. In one embodiment, bridge rings are one or two carbon atoms. It is noted that a bridge always converts a monocyclic ring into a bicyclic ring. When a ring is bridged, the substituents recited for the ring may also be present on the bridge. Fused (e.g., naphthyl and tetrahydronaphthyl) and spiro rings are also included.

“Cycloalkyl” refers to cyclic alkyl groups of from 3 to 10 carbon atoms having single or multiple cyclic rings including fused, bridged, and spiro ring systems. Examples of suitable cycloalkyl groups include, for instance, adamantyl, cyclopropyl, cyclobutyl, cyclopentyl, cyclooctyl and the like. Such cycloalkyl groups include, by way of example, single ring structures such as cyclopropyl, cyclobutyl, cyclopentyl, cyclooctyl, and the like, or multiple ring structures such as adamantanyl, and the like.

The term “substituted cycloalkyl” refers to cycloalkyl groups having from 1 to 5 substituents, or from 1 to 3 substituents, selected from alkyl, substituted alkyl, alkoxy, substituted alkoxy, cycloalkyl, substituted cycloalkyl, cycloalkenyl, substituted cycloalkenyl, acyl, acylamino, acyloxy, amino, substituted amino, aminoacyl, aminoacyloxy, oxyaminoacyl, azido, cyano, halogen, hydroxyl, oxo, thioketo, carboxyl, carboxylalkyl, thioaryloxy, thioheteroaryloxy, thioheterocyclooxy, thiol, thioalkoxy, substituted thioalkoxy, aryl, aryloxy, heteroaryl, heteroaryloxy, heterocyclyl, heterocyclooxy, hydroxyamino, alkoxyamino, nitro, —SO-alkyl, —SO-substituted alkyl, —SO-aryl, —SO-heteroaryl, —SO₂-alkyl, —SO₂-substituted alkyl, —SO₂-aryl and —SO₂-heteroaryl.

“Cycloalkenyl” refers to non-aromatic cyclic alkyl groups of from 3 to 10 carbon atoms having single or multiple rings and having at least one double bond and preferably from 1 to 2 double bonds.

The term “substituted cycloalkenyl” refers to cycloalkenyl groups having from 1 to 5 substituents, or from 1 to 3 substituents, selected from alkoxy, substituted alkoxy, cycloalkyl, substituted cycloalkyl, cycloalkenyl, substituted cycloalkenyl, acyl, acylamino, acyloxy, amino, substituted amino, aminoacyl, aminoacyloxy, oxyaminoacyl, azido, cyano, halogen, hydroxyl, keto, thioketo, carboxyl, carboxylalkyl, thioaryloxy, thioheteroaryloxy, thioheterocyclooxy, thiol, thioalkoxy, substituted thioalkoxy, aryl, aryloxy, heteroaryl, heteroaryloxy, heterocyclyl, heterocyclooxy, hydroxyamino, alkoxyamino, nitro, —SO-alkyl, —SO-substituted alkyl, —SO-aryl, —SO-heteroaryl, —SO₂-alkyl, —SO₂-substituted alkyl, —SO₂-aryl and —SO₂-heteroaryl.

“Cycloalkynyl” refers to non-aromatic cycloalkyl groups of from 5 to 10 carbon atoms having single or multiple rings and having at least one triple bond.

“Cycloalkoxy” refers to —O-cycloalkyl.

“Cycloalkenyloxy” refers to —O-cycloalkenyl.

“Halo” or “halogen” refers to fluoro, chloro, bromo, and iodo.

“Hydroxy” or “hydroxyl” refers to the group —OH.

“Heteroaryl” refers to an aromatic group of from 1 to 15 carbon atoms, such as from 1 to 10 carbon atoms and 1 to 10 heteroatoms selected from the group consisting of oxygen, nitrogen, and sulfur within the ring. Such heteroaryl groups can have a single ring (such as, pyridinyl, imidazolyl or furyl) or multiple condensed rings in a ring system (for example as in groups such as, indolizinyl, quinolinyl, benzofuran, benzimidazolyl or benzothienyl), wherein at least one ring within the ring system is aromatic and at least one ring within the ring system is aromatic, provided that the point of attachment is through an atom of an aromatic ring. In certain embodiments, the nitrogen and/or sulfur ring atom(s) of the heteroaryl group are optionally oxidized to provide for the N-oxide (N→O), sulfinyl, or sulfonyl moieties. This term includes, by way of example, pyridinyl, pyrrolyl, indolyl, thiophenyl, and furanyl. Unless otherwise constrained by the definition for the heteroaryl substituent, such heteroaryl groups can be optionally substituted with 1 to 5 substituents, or from 1 to 3 substituents, selected from acyloxy, hydroxy, thiol, acyl, alkyl, alkoxy, alkenyl, alkynyl, cycloalkyl, cycloalkenyl, substituted alkyl, substituted alkoxy, substituted alkenyl, substituted alkynyl, substituted cycloalkyl, substituted cycloalkenyl, amino, substituted amino, aminoacyl, acylamino, alkaryl, aryl, aryloxy, azido, carboxyl, carboxylalkyl, cyano, halogen, nitro, heteroaryl, heteroaryloxy, heterocyclyl, heterocyclooxy, aminoacyloxy, oxyacylamino, thioalkoxy, substituted thioalkoxy, thioaryloxy, thioheteroaryloxy, —SO-alkyl, —SO-substituted alkyl, —SO-aryl, —SO— heteroaryl, —SO₂-alkyl, —SO₂-substituted alkyl, —SO₂-aryl and —SO₂-heteroaryl, and trihalomethyl.

The term “heteroaralkyl” refers to the groups -alkylene-heteroaryl where alkylene and heteroaryl are defined herein. This term includes, by way of example, pyridylmethyl, pyridylethyl, indolylmethyl, and the like.

“Heteroaryloxy” refers to —O-heteroaryl.

“Heterocycle,” “heterocyclic,” “heterocycloalkyl,” and “heterocyclyl” refer to a saturated or unsaturated group having a single ring or multiple condensed rings, including fused bridged and spiro ring systems, and having from 3 to 20 ring atoms, including 1 to 10 hetero atoms. These ring atoms are selected from the group consisting of nitrogen, sulfur, or oxygen, wherein, in fused ring systems, one or more of the rings can be cycloalkyl, aryl, or heteroaryl, provided that the point of attachment is through the non-aromatic ring. In certain embodiments, the nitrogen and/or sulfur atom(s) of the heterocyclic group are optionally oxidized to provide for the N-oxide, —S(O)—, or —SO₂-moieties.

Examples of heterocycles and heteroaryls include, but are not limited to, azetidine, pyrrole, imidazole, pyrazole, pyridine, pyrazine, pyrimidine, pyridazine, indolizine, isoindole, indole, dihydroindole, indazole, purine, quinolizine, isoquinoline, quinoline, phthalazine, naphthylpyridine, quinoxaline, quinazoline, cinnoline, pteridine, carbazole, carboline, phenanthridine, acridine, phenanthroline, isothiazole, phenazine, isoxazole, phenoxazine, phenothiazine, imidazolidine, imidazoline, piperidine, piperazine, indoline, phthalimide, 1,2,3,4-tetrahydroisoquinoline, 4,5,6,7-tetrahydrobenzo[b]thiophene, thiazole, thiazolidine, thiophene, benzo[b]thiophene, morpholinyl, thiomorpholinyl (also referred to as thiamorpholinyl), 1,1-dioxothiomorpholinyl, piperidinyl, pyrrolidine, tetrahydrofuranyl, and the like.

Unless otherwise constrained by the definition for the heterocyclic substituent, such heterocyclic groups can be optionally substituted with 1 to 5, or from 1 to 3 substituents, selected from alkoxy, substituted alkoxy, cycloalkyl, substituted cycloalkyl, cycloalkenyl, substituted cycloalkenyl, acyl, acylamino, acyloxy, amino, substituted amino, aminoacyl, aminoacyloxy, oxyaminoacyl, azido, cyano, halogen, hydroxyl, oxo, thioketo, carboxyl, carboxylalkyl, thioaryloxy, thioheteroaryloxy, thioheterocyclooxy, thiol, thioalkoxy, substituted thioalkoxy, aryl, aryloxy, heteroaryl, heteroaryloxy, heterocyclyl, heterocyclooxy, hydroxyamino, alkoxyamino, nitro, —SO-alkyl, —SO-substituted alkyl, —SO-aryl, —SO-heteroaryl, —SO₂-alkyl, —SO₂-substituted alkyl, —SO₂-aryl, —SO₂-heteroaryl, and fused heterocycle.

“Nitro” refers to the group —NO₂.

“Oxo” refers to the atom (═O).

“Sulfonyl” refers to the group SO₂-alkyl, SO₂-substituted alkyl, SO₂-alkenyl, SO₂-substituted alkenyl, SO₂-cycloalkyl, SO₂-substituted cycloalkyl, SO₂-cycloalkenyl, SO₂-substituted cylcoalkenyl, SO₂-aryl, SO₂-substituted aryl, SO₂-heteroaryl, SO₂-substituted heteroaryl, SO₂-heterocyclic, and SO₂-substituted heterocyclic, wherein alkyl, substituted alkyl, alkenyl, substituted alkenyl, alkynyl, substituted alkynyl, cycloalkyl, substituted cycloalkyl, cycloalkenyl, substituted cycloalkenyl, aryl, substituted aryl, heteroaryl, substituted heteroaryl, heterocyclic, and substituted heterocyclic are as defined herein. Sulfonyl includes, by way of example, methyl-SO₂—, phenyl-SO₂—, and 4-methylphenyl-SO₂—.

“Thiol” refers to the group —SH.

“Thioxo” or the term “thioketo” refers to the atom (═S).

“Alkylthio” or the term “thioalkoxy” refers to the group —S-alkyl, wherein alkyl is as defined herein. In certain embodiments, sulfur may be oxidized to —S(O)—. The sulfoxide may exist as one or more stereoisomers.

The term “substituted thioalkoxy” refers to the group —S-substituted alkyl.

The term “thioaryloxy” refers to the group aryl-S— wherein the aryl group is as defined herein including optionally substituted aryl groups also defined herein.

In addition to the disclosure herein, the term “substituted,” when used to modify a specified group or radical, can also mean that one or more hydrogen atoms of the specified group or radical are each, independently of one another, replaced with the same or different substituent groups as defined below.

In addition to the groups disclosed with respect to the individual terms herein, substituent groups for substituting for one or more hydrogens (any two hydrogens on a single carbon can be replaced with ═O, ═NR⁷⁰, ═N—OR⁷⁰, ═N₂ or ═S) on saturated carbon atoms in the specified group or radical are, unless otherwise specified, —R⁶⁰, halo, ═O, —OR⁷⁰, —SR⁷⁰, —NR⁸⁰R⁸⁰, trihalomethyl, —CN, —OCN, —SCN, —NO, —NO₂, ═N₂, —N₃, —SO₂R⁷⁰, —SO₂O⁻M⁺, —SO₂OR⁷⁰, —OSO₂R⁷⁰, —OSO₂O⁻M⁺, —OSO₂OR⁷⁰, —P(O)(O⁻)₂(M⁺)₂, —P(O)(OR⁷⁰)O-M⁺, —P(O)(OR⁷⁰) 2, —C(O)R⁷⁰, —C(S)R⁷⁰, —C(NR⁷⁰)R⁷⁰, —C(O)O-M⁺, —C(O)OR⁷⁰, —C(S)OR⁷⁰, —C(O)NR⁸⁰R⁸⁰, —C(NR⁷⁰)NR⁸⁰R⁸⁰, —OC(O)R⁷⁰, —OC(S)R⁷⁰, —O C(O)O⁻M⁺, —OC(O)OR⁷⁰, —OC(S)OR⁷⁰, —NR⁷⁰C(O)R⁷⁰, —NR⁷⁰C(S)R⁷⁰, —NR⁷⁰CO₂M⁺, —NR⁷⁰CO₂R⁷⁰, —NR⁷⁰C(S)OR⁷⁰, —NR⁷⁰C(O)NR⁸⁰R⁸⁰, —NR⁷⁰C(NR⁷⁰)R⁷⁰ and —NR⁷⁰C(NR⁷⁰)NR⁸⁰R⁸⁰, where R⁶⁰ is selected from the group consisting of optionally substituted alkyl, cycloalkyl, heteroalkyl, heterocycloalkylalkyl, cycloalkylalkyl, aryl, arylalkyl, heteroaryl and heteroarylalkyl, each R⁷⁰ is independently hydrogen or R⁶⁰; each R⁸⁰ is independently R⁷⁰ or alternatively, two R⁸⁰'s, taken together with the nitrogen atom to which they are bonded, form a 5-, 6- or 7-membered heterocycloalkyl which may optionally include from 1 to 4 of the same or different additional heteroatoms selected from the group consisting of O, N and S, of which N may have —H or C₁-C₃ alkyl substitution; and each M⁺ is a counter ion with a net single positive charge. Each M⁺ may independently be, for example, an alkali ion, such as K⁺, Na⁺, Li⁺; an ammonium ion, such as ⁺N(R⁶⁰)₄; or an alkaline earth ion, such as [Ca²⁺]_{0.5}, [Mg²⁺]_{0.5}, or [Ba²⁺]_{0.5} (subscript 0.5 means that one of the counter ions for such divalent alkali earth ions can be an ionized form of a compound of the present disclosure and the other a typical counter ion such as chloride, or two ionized compounds disclosed herein can serve as counter ions for such divalent alkali earth ions, or a doubly ionized compound of the invention can serve as the counter ion for such divalent alkali earth ions). As specific examples, —NR⁸⁰R⁸⁰ is meant to include —NH₂, —NH-alkyl, N-pyrrolidinyl, N-piperazinyl, 4N-methyl-piperazin-1-yl and N-morpholinyl.

In addition to the disclosure herein, substituent groups for hydrogens on unsaturated carbon atoms in “substituted” alkene, alkyne, aryl and heteroaryl groups are, unless otherwise specified, —R⁶⁰, halo, —O-M⁺, —OR⁷⁰, —SR⁷⁰, —S-M⁺, —NR⁸⁰R⁸⁰, trihalomethyl, —CF₃, —CN, —OCN, —SCN, —NO, —NO₂, —N₃, —SO₂R⁷⁰, —SO₃⁻M⁺, —SO₃R⁷⁰, —OSO₂R⁷⁰, —OSO₃-M⁺, —OSO₃R⁷⁰, —PO₃⁻²(M⁺)₂, —P(O)(OR⁷⁰)O⁻M⁺, —P(O)(OR⁷⁰)₂, —C(O)R⁷⁰, —C(S)R⁷⁰, —C(NR⁷⁰)R⁷⁰, —CO₂M⁺, —CO₂R⁷⁰, —C(S)OR⁷⁰, —C(O)NR⁸⁰R⁸⁰, —C(NR⁷⁰)NR⁸⁰R⁸⁰, —OC(O)R⁷⁰, —OC(S)R⁷⁰, —OC O₂⁻M⁺, —OCO₂R⁷⁰, —OC(S)OR⁷⁰, —NR⁷⁰C(O)R⁷⁰, —NR⁷⁰C(S)R⁷⁰, —NR⁷⁰CO₂M⁺, —NR⁷⁰CO₂R⁷⁰, —NR⁷⁰C(S)OR⁷⁰, —NR⁷⁰C(O)NR⁸⁰R⁸⁰, —NR⁷⁰C(NR⁷⁰)R⁷⁰ and —NR⁷⁰C(NR⁷⁰)NR⁸⁰R⁸⁰, where R⁶⁰, R⁷⁰, R⁸⁰ and M⁺ are as previously defined, provided that in case of substituted alkene or alkyne, the substituents are not —O-M⁺, —OR⁷⁰, —SR⁷⁰, or -S⁻M⁺.

In addition to the groups disclosed with respect to the individual terms herein, substituent groups for hydrogens on nitrogen atoms in “substituted” heteroalkyl and cycloheteroalkyl groups are, unless otherwise specified, —R⁶⁰, —O-M⁺, —OR⁷⁰, —SR⁷⁰, —S-M⁺, —NR⁸⁰R⁸⁰, trihalomethyl, —CF₃, —CN, —NO, —NO₂, —S(O)₂R⁷⁰, —S(O)₂O⁻M⁺, —S(O)₂OR⁷⁰, —OS(O)₂R⁷⁰, —OS(O)₂O⁻M⁺, —OS(O)₂OR⁷⁰, —P(O)(O—)₂(M⁺)₂, —P(O)(OR⁷⁰)O⁻M⁺, —P(O)(OR⁷⁰)(OR⁷⁰), —C(O)R⁷⁰, —C(S)R⁷⁰, —C(NR⁷⁰)R⁷⁰, —C(O)OR⁷⁰, —C(S)OR⁷⁰, —C(O)NR⁸⁰R⁸⁰, —C(NR⁷⁰)NR⁸⁰R⁸⁰, —OC(O)R⁷⁰, —OC(S)R⁷⁰, —OC(O)OR⁷⁰, —OC(S)OR⁷⁰, —NR⁷⁰C(O)R⁷⁰, —NR⁷⁰C(S)R⁷⁰, —NR⁷⁰C(O)OR⁷⁰, —NR⁷⁰C(S)OR⁷⁰, —NR⁷⁰C(O)NR⁸⁰R⁸⁰, —NR⁷⁰C(NR⁷⁰)R⁷⁰ and —NR⁷⁰C(NR⁷⁰)NR⁸⁰R⁸⁰, where R⁶⁰, R⁷⁰, R⁸⁰ and M⁺ are as previously defined.

In addition to the disclosure herein, in a certain embodiment, a group that is substituted has 1, 2, 3, or 4 substituents, 1, 2, or 3 substituents, 1 or 2 substituents, or 1 substituent.

It is understood that in all substituted groups defined above, polymers arrived at by defining substituents with further substituents to themselves (e.g., substituted aryl having a substituted aryl group as a substituent which is itself substituted with a substituted aryl group, which is further substituted by a substituted aryl group, etc.) are not intended for inclusion herein. In such cases, the maximum number of such substitutions is three. For example, serial substitutions of substituted aryl groups specifically contemplated herein are limited to substituted aryl-(substituted aryl)-substituted aryl.

Unless indicated otherwise, the nomenclature of substituents that are not explicitly defined herein are arrived at by naming the terminal portion of the functionality followed by the adjacent functionality toward the point of attachment. For example, the substituent “arylalkyloxycarbonyl” refers to the group (aryl)-(alkyl)-O—C(O)—.

As to any of the groups disclosed herein which contain one or more substituents, it is understood, of course, that such groups do not contain any substitution or substitution patterns which are sterically impractical and/or synthetically non-feasible. In addition, the subject compounds include all stereochemical isomers arising from the substitution of these compounds.

“Stereoisomer” and “stereoisomers” refer to compounds that have same atomic connectivity but different atomic arrangement in space. Stereoisomers include cis-trans isomers, E and Z isomers, enantiomers, and diastereomers.

“Tautomer” refers to alternate forms of a molecule that differ only in electronic bonding of atoms and/or in the position of a proton, such as enol-keto and imine-enamine tautomers, or the tautomeric forms of heteroaryl groups containing a —N═C(H)—NH— ring atom arrangement, such as pyrazoles, imidazoles, benzimidazoles, triazoles, and tetrazoles. A person of ordinary skill in the art would recognize that other tautomeric ring atom arrangements are possible.

By the term “functional groups” is meant chemical groups such as halo, hydroxyl, sulfhydryl, C₁-C₂₄ alkoxy, C₂-C₂₄ alkenyloxy, C₂-C₂₄ alkynyloxy, C₅-C₂₀ aryloxy, acyl (including C₂-C₂₄ alkylcarbonyl (—CO-alkyl) and C₆-C₂₀ arylcarbonyl (—CO-aryl)), acyloxy (—O-acyl), C₂-C₂₄ alkoxycarbonyl (—(CO)—O-alkyl), C₆-C₂₀ aryloxycarbonyl (—(CO)—O-aryl), halocarbonyl (—CO)—X where X is halo), C₂-C₂₄ alkylcarbonato (—O—(CO)—O-alkyl), C₆-C₂₀ arylcarbonato (—O—(CO)—O-aryl), carboxy (—COOH), carboxylato (—COO—), carbamoyl (—(CO)—NH₂), mono-substituted C₁-C₂₄ alkylcarbamoyl (—(CO)—NH(C₁-C₂₄ alkyl)), di-substituted alkylcarbamoyl (—(CO)—N(C₁-C₂₄ alkyl)₂), mono-substituted arylcarbamoyl (—(CO)—NH-aryl), thiocarbamoyl (—(CS)—NH₂), carbamido (—NH—(CO)—NH₂), cyano (—C═N), isocyano (—N+=C—), cyanato (—O—C═N), isocyanato (—O—N+=C—), isothiocyanato (—S—C═N), azido (—N═N+=N—), formyl (—(CO)—H), thioformyl (—(CS)—H), amino (—NH₂), mono- and di-(C₁-C₂₄ alkyl)-substituted amino, mono- and di-(C₅-C₂₀ aryl)-substituted amino, C₂-C₂₄ alkylamido (—NH—(CO)-alkyl), C₅-C₂₀ arylamido (—NH—(CO)-aryl), imino (—CR═NH where R=hydrogen, C₁-C₂₄ alkyl, C₅-C₂₀ aryl, C₆-C₂₀ alkaryl, C₆-C₂₀ aralkyl, etc.), alkylimino (—CR═N(alkyl), where R=hydrogen, alkyl, aryl, alkaryl, etc.), arylimino (—CR═N(aryl), where R=hydrogen, alkyl, aryl, alkaryl, etc.), nitro (—NO₂), nitroso (—NO), sulfo (—SO₂—OH), sulfonato (—SO₂—O—), C₁-C₂₄ alkylsulfanyl (—S-alkyl; also termed “alkylthio”), arylsulfanyl (—S-aryl; also termed “arylthio”), C₁-C₂₄ alkylsulfinyl (—(SO)-alkyl), C₅-C₂₀ arylsulfinyl (—(SO)-aryl), C₁-C₂₄ alkylsulfonyl (—SO₂-alkyl), C₅-C₂₀ arylsulfonyl (—SO₂-aryl), phosphono (—P(O)(OH)₂), phosphonato (—P(O)(O—)₂), phosphinato (—P(O)(O—)), phospho (—PO₂), and phosphino (—PH₂), mono- and di-(C₁-C₂₄ alkyl)-substituted phosphino, mono- and di-(C₅-C₂₀ aryl)-substituted phosphine. In addition, the aforementioned functional groups may, if a particular group permits, be further substituted with one or more additional functional groups or with one or more hydrocarbyl moieties such as those specifically enumerated above.

Unless otherwise specified, reference to an atom is meant to include isotopes of that atom. For example, reference to H is meant to include ¹H, ²H (i.e., D) and ³H (i.e., T), and reference to C is meant to include ¹²C and all isotopes of carbon (such as ¹³C).

### DETAILED DESCRIPTION

Provided are methods of forming a carbon-carbon bond between a first compound and a second compound through a hydroarylation chemical reaction. The methods include contacting the first compound and the second compound in the presence of an acid catalyst. The methods include forming a carbon-carbon bond wherein the first compound includes a first aryl group that is electron-deficient. Provided is a method of generating a quaternary carbon through a hydroarylation chemical reaction.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the apparatus and method has or will be described for the sake of grammatical fluidity with functional explanations, it is to be expressly understood that the claims, unless expressly formulated under 35 U.S.C. § 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. § 112 are to be accorded full statutory equivalents under 35 U.S.C. § 112.

Methods

Provided are methods of forming a carbon-carbon bond between a first compound and a second compound through a hydroarylation chemical reaction. The methods include contacting the first compound and the second compound in the presence of an acid catalyst. The methods include forming a carbon-carbon bond wherein the first compound includes a first aryl group that is electron-deficient. Provided is a method of generating a quaternary carbon through a hydroarylation chemical reaction.

The first compound comprises a first aryl group and a carbon-carbon double bond that are π-conjugated to one another, wherein the carbon-carbon double bond connects a carbon alpha to the first aryl group and a carbon beta to the first aryl group. As used herein, such carbons are also referred to as the “alpha carbon” and the “beta carbon” respectively. In addition, the term “first alkene group” refers to the group including the alpha carbon and the beta carbon.

The second compound comprises a second aryl group.

The method generates a hydroarylation product by forming a carbon-carbon bond between a carbon of the second aryl group and the alpha carbon or the beta carbon of the first compound. In some cases, the carbon-carbon bond involves the alpha carbon. In some cases, the carbon-carbon bond involves the beta carbon.

It is to be understood that although the described carbon-carbon bond formation can formally be considered as a hydroarylation reaction, the actual chemical reaction might occur through a variety of mechanisms. Thus, the component referred to as an acid catalyst herein might function in any one of a variety of manners.

Acid Catalyst

As described above in the definitions section, the term “acid catalyst” includes Brønsted acids and salts of Brønsted acids. The term “Brønsted acid salt catalyst” refers to an acid catalyst that is a salt of a Brønsted acid. The term “non-coordinating ionic acid catalyst” refers to a Brønsted acid salt catalyst that includes a non-coordinating cation and a non-coordinating anion.

Without intending to be limited by theory, Brønsted acid catalysts and Brønsted acid salt catalysts will generally have a non-coordinating conjugate base or a non-coordinating anion, respectively. Such conjugate bases and anions will generally be less coordinating (i.e., more non-coordinating) than the triflate group (—OTf, which is —O—S(O)₂—CF₃). An exemplary Brønsted acid catalyst with a conjugate base that is less coordinating than triflate is trifluoromethanesulfonimide (Tf₂NH), which has the conjugate base Tf₂N—. Examples of compounds with conjugate bases that are more coordinating than triflate are sulfuric acid and trifluoroacetic acid (TFA).

Without intending to be limited by theory, Brønsted acid salt catalysts will generally have a non-coordinating cation. As such, Brønsted acid salt catalysts will generally have a non-coordinating cation and a non-coordinating anion. Stated in another manner, Brønsted acid catalysts will generally be non-coordinating ionic acid catalysts.

In some cases, the Brønsted acid salt catalyst will have a Lewis acid cation. In some cases, the Brønsted acid salt catalyst will have a non-coordinating Lewis acid cation.

An exemplary Brønsted acid catalyst is trifluoromethanesulfonimide (Tf₂NH), which has the conjugate base Tf₂N—. In some cases, the acid catalyst is a derivative of trifluoromethanesulfonimide.

In some cases, the Brønsted acid salt catalyst has a non-coordinating cation selected from the group consisting of a trityl cation (Ph₃C⁺), a trimethylsilyl cation (Me₃Si⁺), and a derivative thereof. For example, the Brønsted acid salt catalyst can have a cation selected from the group consisting of:

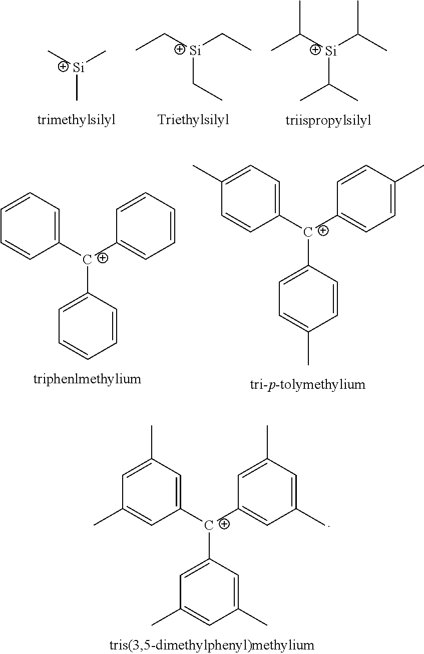

In some cases, the Brønsted acid salt catalyst has a non-coordinating anion that is less coordinating than triflate with the formula [(C₆X₅)₄B]⁻, wherein each X is independently selected from fluorine, hydrogen and trifluoromethyl. In some cases, two or more X are fluorine or trifluoromethyl. In some cases, the Brønsted acid salt catalyst has a non-coordinating ion that is less coordinating than triflate selected from the group consisting of tetra(pentafluorophenyl)borate ((C₆F₅)₄B⁻), tetrakis[3,5-bis(trifluoromethyl)phenyl]borate anion ({3,5-(CF₃)₂C₆H₃}₄B⁻), and derivatives thereof. In some cases, the Brønsted acid salt catalyst has a non-coordinating anion that is less coordinating than triflate with a formula selected from the group consisting of:

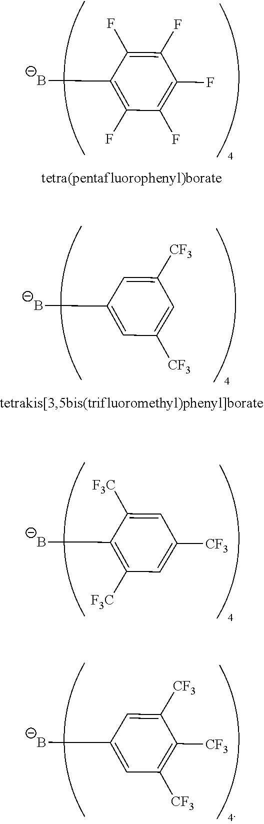

In some cases, the Brønsted acid salt catalyst is triphenylmethyl tetra(pentafluorophenyl)borate ([Ph₃C]+[(C₆F₅)₄B]⁻), trimethylsilyl tetra(pentafluorophenyl)borate ([Me₃Si]+[(C₆F₅)₄B]⁻), triphenylmethyl tetrakis[3,5-bis(trifluoromethyl)phenyl]borate anion ([Ph₃C]+[{3,5-(CF₃)₂C₆H₃}₄B]⁻), or trimethylsilyl tetrakis[3,5-bis(trifluoromethyl)phenyl]borate anion ([Me₃Si]+[{3,5-(CF₃)₂C₆H₃}₄B]⁻). In some cases, the acid catalyst is triphenylmethyl tetra(pentafluorophenyl)borate ([Ph₃C]+[(C₆F₅)₄B]⁻).

In some cases, the acid catalyst is an active catalyst. In other cases, the acid catalyst is a precatalyst.

Without intending to be limited by theory, if the acid catalyst is a Brønsted acid catalyst, then the Brønsted acid will generally have pKa that is greater than the pKa of a carbon of the alkene group of the first compound, e.g. so that the Brønsted acid can protonate the alkene group, as shown below in an exemplary embodiment.

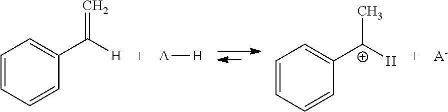

If the acid catalyst is a Brønsted acid salt catalyst, then the corresponding Brønsted acid will generally have pKa that is greater than the pKa of a carbon of the alkene group of the first compound, e.g. so that the Brønsted acid can protonate the alkene group, as shown below in an exemplary embodiment.

First Aryl Group

In some cases, the first aryl group is a phenyl group. As used herein, if the first aryl group is a phenyl group then it is considered neither electron-deficient nor electron-rich. In some cases, the first aryl group is a heteroaryl group.

In some cases, the first aryl group is electron-deficient, i.e. it is substituted with one or more substituents that cause a net withdrawal of electron density from the ipso atom of the aryl group. The ipso atom refers to the atom of the first aryl group that is connected to the alpha carbon. Any feasible substituent can be used, e.g. halogen, haloalkyl, cyano, nitro, nitroso, ammonium, sulfonyl, phosphoryl, acyl, and amide. It is recognized that whether some substituents are electron-withdrawing or electron-donating depends upon their location, e.g. ortho, meta, or para. Thus, an electron-withdrawing substituent refers a group that is electron withdrawing at its present location on the aryl group.

In some cases, the first aryl group is substituted with a haloalkyl group. In some cases, the first aryl group is substituted with a trifluoromethyl group. In some cases, the trifluoromethyl group is ortho to the ipso atom of the first aryl group, wherein the ipso atom has a bond to the alpha carbon of the first alkene group. In some cases, the trifluoromethyl group is meta to the ipso atom of the first aryl group. In some cases, the trifluoromethyl group is para to the ipso atom of the first aryl group.

In some cases, the first aryl group is substituted with a haloalkyl group, a nitro group, an acyl group, or a cyano group.

In some cases, the first aryl group is electron-rich, i.e. it is substituted with one or more substituents that cause a net donation of electron density into the ipso atom of the aryl group.

In some case, the first aryl group is substituted with two or more groups that are connected to one another, thereby forming another cyclic structure. For example, if a first aryl group is a phenyl group that is fused with another phenyl group, a naphthalene group will result. In other cases, the second group is not aromatic. Any feasible group can be employed in such cases, resulting in a net increase in electron density of the ipso carbon, a net decrease, or no net change.

First Alkene Group

As described above, the first alkene group is the group including the alpha carbon and the beta carbon

In some cases, the alpha carbon of the first alkene group has a C═C bond to the beta carbon, a single bond to the ipso atom of the first aryl ring, and a C—H bond. In other cases, the alpha carbon has a C═C bond to the beta carbon, a single bond to the ipso atom of the first aryl ring, and a single bond to a non-hydrogen group. In such cases, the alpha carbon can be considered to be substituted, and it can be substituted with any feasible hydrocarbyl or non-hydrocarbyl group. In some cases, the alpha carbon is substituted with an alkyl group, e.g. a methyl group or an ethyl group.

In some cases, the first alkene group is a terminal group, i.e. the beta carbon has a C═C bond to the alpha carbon and two C—H bonds. In other cases, in addition to the C═C bond to the alpha carbon, the beta carbon has a bond to a non-hydrogen atom. In some cases, the beta carbon has a bond to an alkyl group, e.g. a methyl group or an ethyl group. In some cases, the beta carbon has a bond to a hydrogen atom and a bond to an alkyl group, e.g. a methyl group. In some case, the beta carbon is bonded to an aryl group.

Second Aryl Group

In some cases, the second aryl group is a phenyl group, i.e. it is neither electron-rich nor electron-deficient. In other cases, the second aryl group a substituted phenyl group. In some cases, the second aryl group can be electron-rich, i.e. the ipso atom is electron-rich compared to the ipso atom of a phenyl group. For the second aryl group, the ipso atom is the atom that forms the carbon-carbon bond with the first compound. In other cases, the second aryl group can be electron-deficient, i.e. electron-poor.

In some cases, the second aryl group is a heteroaryl group.

The second aryl group can be substituted with any feasible substituent, e.g. halogen, haloalkyl, cyano, nitro, nitroso, ammonium, sulfonyl, phosphoryl, acyl, and amide. It is recognized that whether some substituents are electron-withdrawing or electron-donating depends upon their location, e.g. ortho, meta, or para. Thus, an electron-withdrawing substituent refers a group that is electron withdrawing at its present location on the aryl group.

In some case, the second aryl group is substituted with two or more groups that are connected to one another, thereby forming another cyclic structure. For example, if a second aryl group is a phenyl group that is fused with another phenyl group, a naphthalene group will result. In other cases, the second group is not aromatic. Any feasible group can be employed in such cases, resulting in a net increase in electron density of the ipso carbon, a net decrease, or no net change.

In some cases, the second aryl group is substituted with a group selected from: alkyl, alkoxy, hydroxy, amine, thiol, and a combination thereof. In some cases, the second aryl group is substituted with a group selected from methyl, ethyl, n-butyl, t-butyl, methoxy, —NH₂, —C(O)Me, —SH, and a combination thereof. In some cases, the second aryl group is substituted with two or more groups. In some cases, the second aryl group is fused with an aryl or cycloalkyl group.

Contacting Conditions

As used herein, contacting conditions and reaction conditions are used interchangeably.

The method can be performed with a variety of solvents, or without a solvent. In some cases, the solvent is an aprotic solvent. In some cases the solvent is a haloalkane, e.g. 1,2-dichloroethane (DCE). In other cases, the solvent is chloroform, dichloromethane, methylene chloride, tetrahydrofuran, or 1,4-dioxane.

In some case, the concentration of first compound during the contacting ranges from 0.01 M to 1 M, such as from 0.05 M to 0.5 M. In some cases, the contacting involves a temperature of 120° C. or less, such as 100° C. or less, or 90° C. or less. In some cases, the contacting is performed for 10 hours or less, such as 8 hours or less, or 5 hours or less.

In some cases, the mole ratio of the acid catalyst to the first compound is 5:100 or less, such as 2:100 or less, 1:100 or less, or 0.1:100 or less. In some cases, the mole ratio of the first compound to the second compound ranges from 1:1 to 1:10, such as from 1:2 to 1:8 or from 1:3 to 1:7.

Results of the Contacting Step

In some cases, the method generates one or more hydroarylation products and one or more side products. The one or more hydroarylation products can be an alpha hydroarylation product, as described below, a beta hydroarylation product, as also described below, or a combination thereof. The one or more side products can include regioisomer side products, dimerization side products, polymerization side products, other side products, or a combination thereof.

The method can generate a hydroarylation product wherein the second aryl group is connected to the alpha carbon, which is referred to herein as the alpha hydroarylation product. The method can generate a hydroarylation product wherein the second aryl group is connected to the beta carbon, which is referred to herein as the beta hydroarylation product. The method can generate both the alpha and beta hydroarylation products. In some cases, the method is selective for the alpha product, i.e. wherein more alpha product is generated than beta product. In some cases, the ratio of alpha:beta products is 2:1 or greater, such as 3:1 or greater, 5:1 or greater, 10:1 or greater, or 20:1 or greater. In some cases, the method generates the alpha product and no or substantially no beta product.

In some cases, the method generates a quaternary carbon atom. In such cases, the method can also be referred to as a method of generating a quaternary carbon atom, i.e. through a hydroarylation reaction.

An exemplary reaction within the scope of the described methods that generates a quaternary carbon is shown below. In particular, in addition to bonds to the beta carbon and the first aryl group, the alpha carbon has a bond to another group, e.g. a methyl group as shown in the exemplary reaction scheme below. Thus, if such a first compound is contacted with a second compound in the presence of an acid catalyst, and if the method generates an alpha hydroarylation product, then the alpha carbon becomes a quaternary carbon atom in the product.

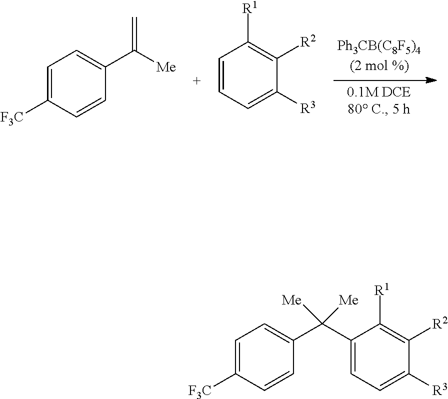

In cases wherein the method generates a beta hydroarylation product, in some cases the method generates a quaternary beta carbon. For example, if the beta carbon had a C═C double bond and two C-alkyl bonds, beta hydroarylation would result in a product wherein the beta carbon had two C-alkyl bonds, one C—C bond to the alpha carbon, and one bond to the second aryl group.

The one or more side products can include regioisomer side products, dimerization side products, polymerization side products, other side products, or a combination thereof. In some cases, the dimerization side products include a compound formed by dimerization of two first compounds.

In some cases, the ratio of the mass of the product to the combined mass of all side products is 1:1 or more, such as 1:10 or more. In some cases, the yield of the method is 50% or greater compared with the theoretical yield, e.g. 75% or greater, 90% or greater, or 95% or greater.

In some cases, the method results is regioselective in relation to the second aryl group. As an example, if the second compound was propyl benezene (Ph-CH₂—CH₂—CH₃), the method might selectively generate a product wherein the propyl group is para relative to the bond to the first compound. Stated in another manner, the method would be regioselective for the “para product” if the amount of para product was greater than any of the ortho product and the meta product. For example, if the ratio of para:meta:ortho isomer products was 40%, 35%, and 25% respectively, then the method would be regioselective for the para product and the regioselectivity would be 40%. As such, in some cases the regioselectivity is 40% or greater, 50% or greater, 75% or greater, 90% or greater, or 95% or greater.

In some cases, the method is selective for one or more hydroarylation products, i.e. products generated by formation of a carbon-carbon bond between the second aryl group and a carbon of the first alkene group, compared with dimerization side products, polymerization side products, and other products. For example, if the mass ratio of the hydroarylation product to the dimerization, polymerization, and other products was 70%, 20%, 10%, and 0% respectively, then the method would have a hydroarylation selectivity of 70%. As such, in some cases the hydroarylation selectivity is 40% or greater, 50% or greater, 75% or greater, 90% or greater, or 95% or greater.

In some cases, wherein the ratio of the mass of the product to the combined mass of all dimerization side product formed from the dimerization of two first compounds is 2:1 or more, such as 5:1 or more, 10:1 or more, or 100:1 or more. In some cases, the method generates 1% or less by mass of a dimerization side product formed from the dimerization of two first compounds. In some cases, the method generates 1% or less by mass of polymerization side products.

Without intending to be limited by theory, it is hypothesized that the method generates a hydroarylation product, e.g. an alpha hydroarylation product, through the generalized hypothesized reaction mechanism shown below. HA is an acid catalyst, such as a protonated reactant arene (also known as an arenium ion, or Wheland complex). R¹, R², and R³ are each independently selected from hydrogen and a hydrocarbyl group. R⁴ refers to zero, one, or more than one substitutions on the first aryl group. R⁵ refers to zero, one, or more than one substitution on the second aryl group. The first and second aryl groups are shown as phenyl groups for clarity, but can be independently selected from any suitable homoaryl groups and heteroaryl groups. The carbocation is shown after protonation by HA. The formal cation on the second aryl ring is also shown.

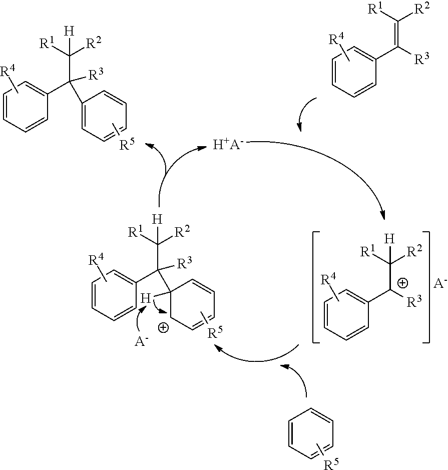

In some cases, A⁻ is a quaternary borate anion. In some cases, R¹, R², and R³ are each independently selected from hydrogen, an alkyl group, an aryl group, and an aryl-alkyl group. In some case, R¹, R², and R³ are each independently selected from hydrogen and an alkyl group. In some cases, R¹ and R² are both hydrogen. In some cases, one or more of R¹ and R² are a hydrocarbyl group, e.g. R¹ is methyl and R² is hydrogen. In some cases, R³ is hydrogen. In some cases R³ is a hydrocarbyl group, and therefore the method is a method of generating a quaternary carbon, i.e. a quaternary alpha carbon.

In some cases, R⁴ is one or more electron-withdrawing substituents. In some cases, R⁵ is located para to the newly formed carbon-carbon bond. In some case, the first aryl group is phenyl. In some cases, the second aryl group is phenyl.

Utility

The subject methods and compounds find use in a variety of fields. The subject methods can be used in the field of organic synthesis to construct a variety of commercially useful molecules, including pharmaceutical compounds as well as fine chemicals. The subject methods can generate hydroarylation products in high yields while also minimizing side products, such as dimerization side products. The hydroarylation carbon-carbon bond forming reaction involves allows for generation of a bond to form a quaternary carbon. Compounds generated with such methods can be useful for a variety of purposes, including as pharmaceutical compositions, fine chemicals, or precursors thereof. As the hydroarylation reactions are catalyzed, no stoichiometric reagents are consumed except for the compounds being covalently bonded to one another.

The following example(s) is/are offered by way of illustration and not by way of limitation.

### EXAMPLES

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

Reagents and kits for methods referred to in, or related to, this disclosure are available from commercial vendors such as BioRad, Agilent Technologies, Thermo Fisher Scientific, Sigma-Aldrich, and the like, as well as repositories such as e.g., Addgene, Inc., American Type Culture Collection (ATCC), and the like.

### Example 1: Effect of Catalyst Identity

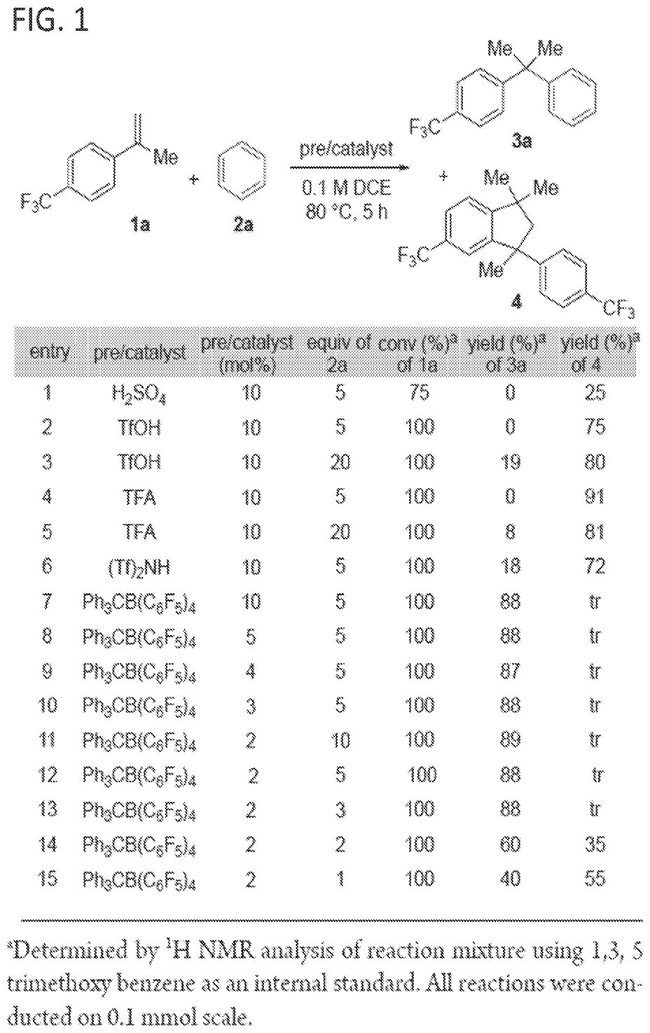

The effect of different catalysts on the conversion and selectivity of a hydroarylation reaction between benzene and p-(trifluoromethyl)-α-methylstyrene was examined. As shown in FIG. 1, the two compounds were combined in various ratios with the solvent being 1,2-dichloroethane (DCE). The concentration of the p-(trifluoromethyl)-α-methylstyrene was 0.1 M. The reaction mixture was heated to 80° C. for 5 hours.

H₂SO₄ refers to sulfuric acid. TfOH refers to triflic acid (CF₃SO₃H). TFA refers to trifluoroacetic acid (CF₃CO₂H). (Tf)₂NH refers to bis(trifluoromethanesulfonyl)amine (CF₃SO₂)₂NH). Ph₃CB(C₆F₅)₄ is abbreviated as TPFPB and refers to triphenylmethyl tetra(pentafluorophenyl)borate. Compound 3a is the observed hydroarylation product.

Compound 4 is the observed product from dimerization of p-(trifluoromethyl)-α-methylstyrene molecules. Yields were determined by ¹H NMR analysis of reaction mixture using 1,3,5-trimethoxy benzene as an internal standard. All reactions were conducted on 0.1 mmol scale.

Entry 3 shows 19% product but 20 equivalents of 1b were needed. Lowering the amount of 1b to 3 equivalents resulted in no desired product but gave 75% yield of 2b (entry 2). Reaction with TFA behaved similarly as the TfOH (entries 4 and 5). Reaction with 10 mol % of (Tf)₂NH only gave 18% of the desired product 2a (entry 6). With TPFPB At 10 mol % catalyst loading and with 5 equivalents of 2a, 3a was made in 88% yield (entry 7). With modifications, 3a was made by only using 2 mol % of TPFPB and 3 equivalents of 2a.

### Example 2: Substrate Scope with Para-Trifluoromethyl Substituted Arenes

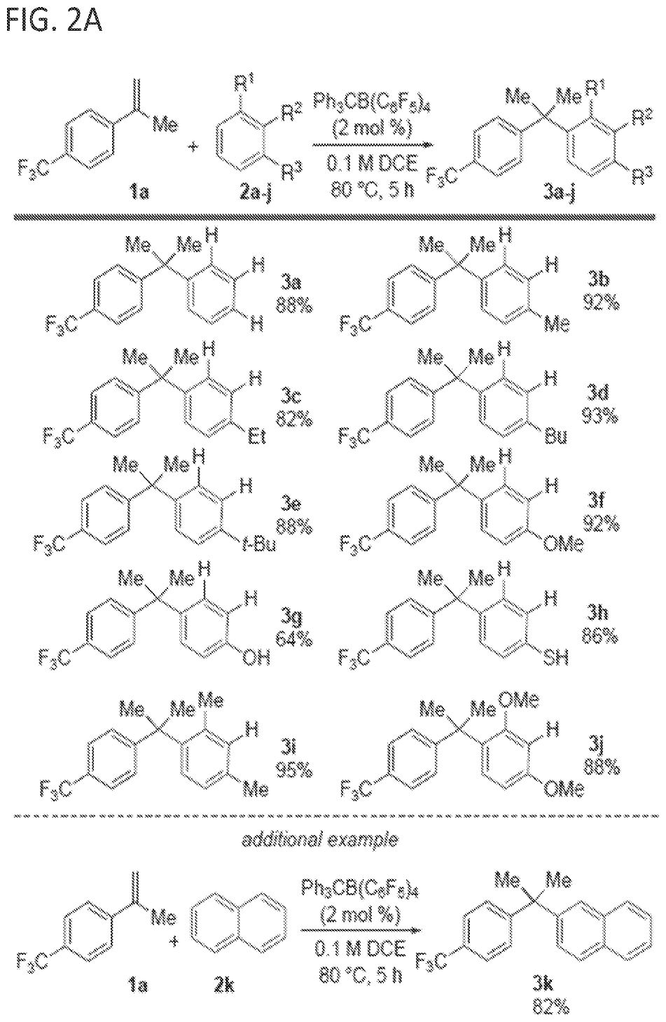

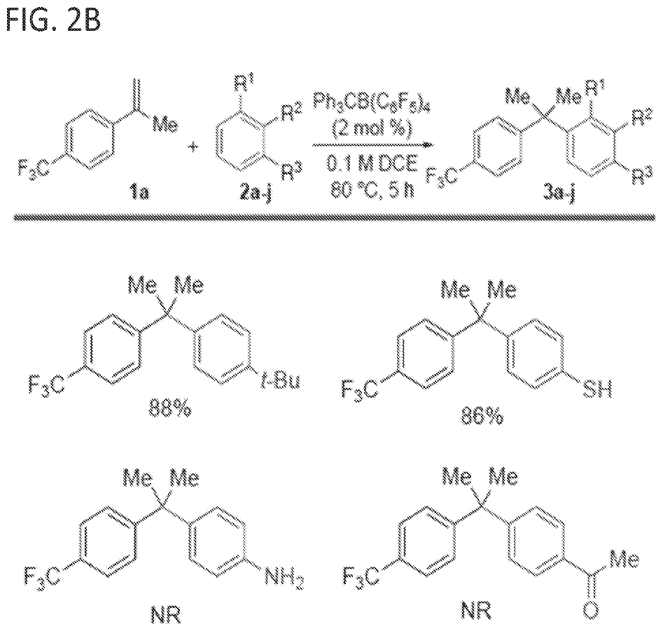

The substrate scope was explored of the intermolecular hydroarylation of p-(trifluoromethyl)-α-methylstyrene (FIGS. 2A and 2B). Reaction conditions were 2 mol % catalyst, 0.1 M of the (trifluoromethyl)-α-methylstyrene, DCE as the solvent, and heating at 80° C. for 5 hours. Isolated yields are reported and starting material was fully consumed unless otherwise noted.

3a was isolated in 88% yield when benzene 2a was used as the nucleophile. Intermolecular hydroarylation with 2b was highly selective toward the para position of toluene and resulted in 92% yield for 3b. A similar trend and regioselectivity was observed with substrates 2b-2h. The desire products 3c-3f were isolated in good yields. Modest yield was obtained when phenol 2g was used as the substrate, and the reaction didn't require O-protection of the substrate. Reaction with thiophenol 2h also did not require S-protection of the substrate and resulted in 86% isolate yield for product 3h. In case of substrate 2i and 2j, again the electronics and sterics dictated the formation of single regioisomers, giving 95% yield for 3i and 88% yield for 3j. In addition to monoaromatic molecules, bicyclic systems like naphthalene 2k gave the desired product 3k in 82% yield.

As shown in FIG. 2B, the reaction was also conducted wherein the arene was para-substituted with tert-butyl, thiol, NH₂, and —C(O)Me groups. The first two compounds gave 88% and 86% yield whereas the last two substrates gave no reaction.

### Example 3: Substrate Scope with Meta-Trifluoromethyl Substituted Arenes

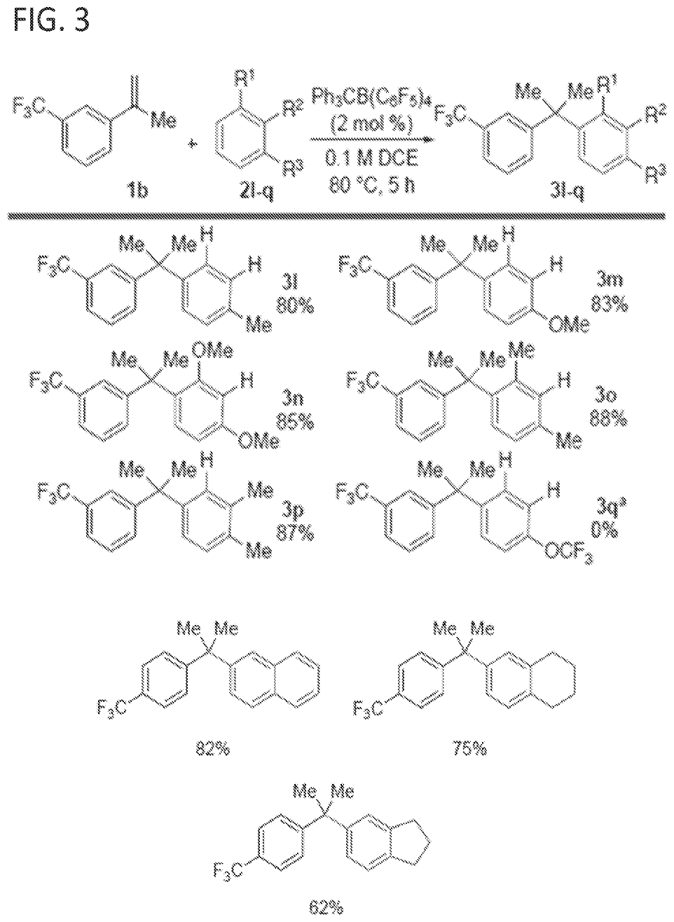

To further explore the scope of this intermolecular hydroarylation reaction, optimized conditions were applied to m-(trifluoromethyl)-α-methylstyrene (FIG. 3). Similar regioselectivity trends for substrates 2i-2p were observed compared to results of Example 2. However, the method did not generate 3q or its regioisomers when trifluoromethoxybenzene 2q was used as the nucleophile.

### Example 4: Substrate Scope with Ortho-Trifluoromethyl Substituted Arenes

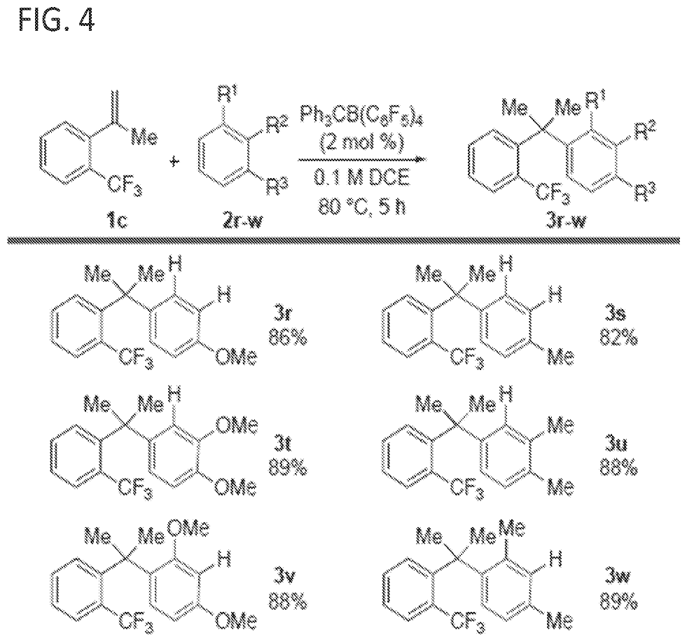

The scope of the intermolecular hydroarylation of o-(trifluoromethyl)-α-methylstyrene was also investigated (FIG. 4). Regioselectivity trends similar to those of Examples 2 and 3 were observed. Intermolecular addition to 1c was favored at the para position of anisole 2r and toluene 2s. In case of substrates 2t-2u, the hydroarylation was favored at the less hindered sites, para to each methoxy and methyl respectively. Finally, hydroarylation at the least hinder site and more nucleophilic position of 2v and 3w gave 3v and 3w in 88% and 89% yield respectively.

### Example 5: Effect of Solvent

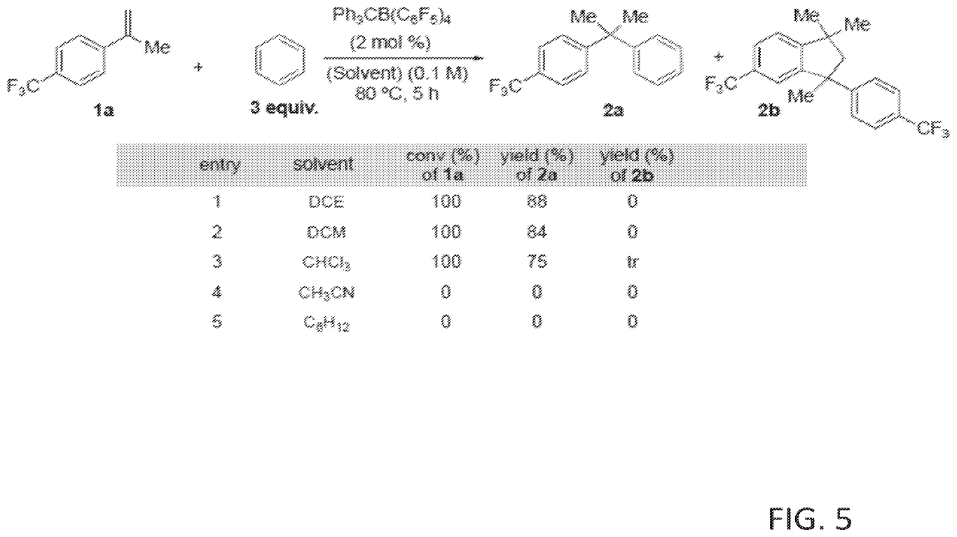

The effect of solvent was investigated by varying the solvent between DCE (1,2-dichloroethane), DCM (dichloromethane), CHCl₃ (chloroform), CH₃CN (acetonitrile), and C₆H₁₂ (benzene). As shown in FIG. 5, 100% conversion and yields of 75% or more were obtained with DCE, DCM, and chloroform. Reactions with acetonitrile and benzene gave no conversion. Reactions were conducted on a 0.1 mmol scale in a small capped vial.

### Example 6: Effect of Substitution on Carbon-Carbon Double Bond

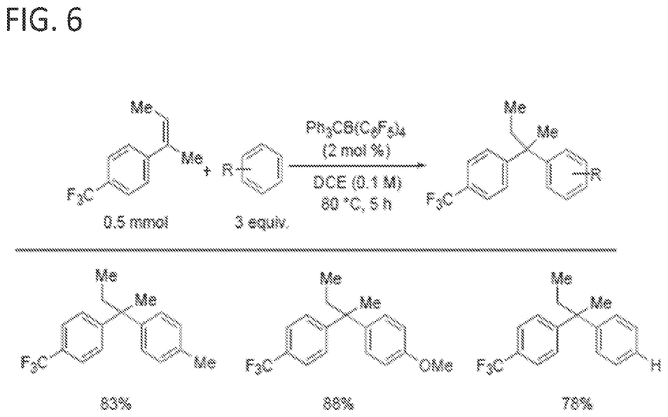

The effect of substitution on the carbon-carbon bond was investigated by employing a substrate containing a methyl substitution on the carbon furthest from the aryl ring, as shown in FIG. 6. Arenes para-substituted with methyl, methoxy, and unsubstituted (i.e. para-H) was tested, and all reactions gave yields above 75%.

Notwithstanding the appended claims, the disclosure is also defined by the following clauses:
1. A method of forming a carbon-carbon bond between a first compound and a second compound, comprising:
   contacting the first compound with the second compound in the presence of an acid catalyst,
   wherein the first compound comprises an electron-deficient first aryl group and a carbon-carbon double bond that are π-conjugated to one another, wherein the carbon-carbon double bond connects a carbon alpha to the first aryl group and a carbon beta to the first aryl group,
   wherein the second compound comprises a second aryl group,
   such that an alpha hydroarylation product is formed with a carbon-carbon bond between the carbon alpha to the first aryl group and a carbon of the second aryl group.
2. The method of clause 1, wherein the acid catalyst is a Brønsted acid.
3. The method of clause 2, wherein a conjugate base of the Brønsted acid is a non-coordinating anion.
4. The method of clause 3, wherein the Brønsted acid is trifluoromethanesulfonimide (Tf₂NH).
5. The method of clause 1, wherein the acid catalyst is a salt of a Brønsted acid.
6. The method of clause 5, wherein the acid catalyst comprises a non-coordinating cation.
7. The method of clause 6, wherein the non-coordinating cation is trityl (Ph₃C⁺), trimethylsilyl (Me₃Si⁺), or a derivative thereof.
8. The method of clause 7, wherein the non-coordinating cation is selected from the group consisting of:

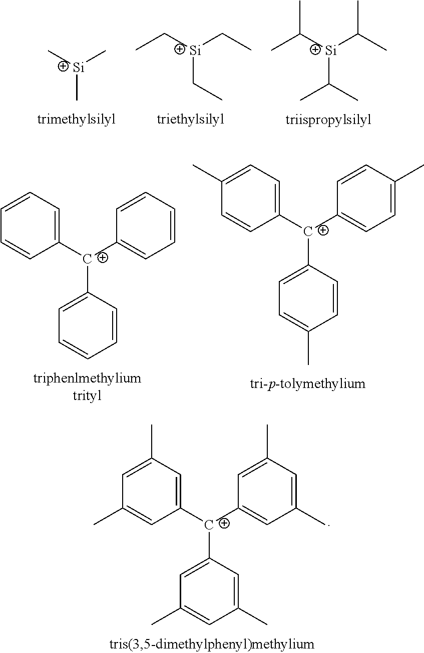

9. The method any one of clauses 1-8, wherein the acid catalyst comprises a non-coordinating anion.
10. The method of clause 9, wherein the non-coordinating anion is less coordinating than triflate.
11. The method of clause 10, wherein the non-coordinating anion has the formula [(C₆X₅)₄B]⁻, wherein each X is independently selected from fluorine, hydrogen and trifluoromethyl.
12. The method of clause 11, wherein the non-coordinating anion has a formula selected from the group consisting of:

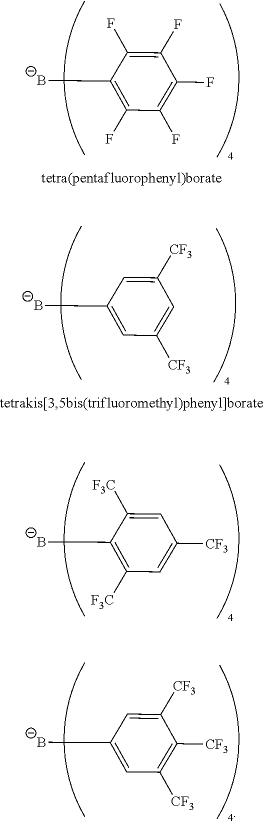

13. The method of clause 12, wherein the non-coordinating anion is tetra(pentafluorophenyl)borate ((C₆F₅)₄B⁻) or tetrakis[3,5-bis(trifluoromethyl)phenyl]borate ({3,5-(CF₃)₂C₆H_{3}4}B⁻).
14. The method of clause 13, wherein the acid catalyst is triphenylmethyl tetra(pentafluorophenyl)borate ([Ph₃C]+[(C₆F₅)₄B]⁻), trimethylsilyl tetra(pentafluorophenyl)borate ([Me₃Si]+[(C₆F₅)₄B]⁻), triphenylmethyl tetrakis[3,5-bis(trifluoromethyl)phenyl]borate anion ([Ph₃C]+[{3,5-(CF₃)₂C₆H₃}₄B]⁻), or trimethylsilyl tetrakis[3,5-bis(trifluoromethyl)phenyl]borate anion ([Me₃Si]+[{3,5-(CF₃)₂C₆H₃}₄B]⁻).
15. The method of clause 14, wherein the acid catalyst is triphenylmethyl tetra(pentafluorophenyl)borate ([Ph₃C]+[(C₆F₅)₄B]⁻).
16. The method of any one of the preceding clauses, wherein the first aryl group is substituted with an electron-withdrawing group selected from: halogen, haloalkyl, cyano, nitro, nitroso, ammonium, sulfonyl, phosphoryl, acyl, and amide.
17. The method of clause 16, wherein the first aryl group is substituted with a haloalkyl.
18. The method of clause 17, wherein the haloalkyl is trifluoromethyl.
19. The method of any one of the preceding clauses, wherein the first aryl group is fused with a third aryl group, wherein the presence of the third aryl group causes a reduction in electron density in the first aryl group.
20. The method of any one of the preceding clauses, wherein the carbon alpha to the first aryl ring has a carbon-carbon double bond to the carbon beta to the first aryl group, a single bond the first aryl ring, and a carbon-hydrogen bond.
21. The method of any one of clauses 1-19, wherein the carbon alpha to the first aryl ring has a carbon-carbon double bond to the carbon beta to the first aryl group, a single bond the first aryl ring, and another bond to a non-hydrogen group, wherein the method is a method of generating a quaternary carbon.
22. The method of clause 21, wherein the non-hydrogen group is an alkyl group.
23. The method of clause 22, wherein the non-hydrogen group is a methyl group or an ethyl group.
24. The method of any one of the preceding clauses, wherein the carbon beta to the first aryl ring has two carbon-hydrogen bonds.
25. The method of any one of clauses 1-23, wherein the carbon beta to the first aryl ring has a carbon-carbon double bond and at least one bond to a non-hydrogen group.
26. The method of clause 25, wherein the non-hydrogen group is an alkyl group.
27. The method of clause 26, wherein the non-hydrogen group is methyl or ethyl.
28. The method of any one of the preceding clauses, wherein the second aryl group is not substituted.
29. The method of any one of clauses 1-27, wherein the second aryl group is substituted with a group selected from: alkyl, alkoxy, hydroxy, amine, thiol, and a combination thereof.
30. The method of clause 29, wherein the second aryl group is substituted with a group selected from methyl, ethyl, n-butyl, t-butyl, methoxy, —NH₂, —C(O)Me, —SH, and a combination thereof.
31. The method of clause 29, wherein the second aryl group is substituted with two or more groups.
32. The method of clause 29, wherein the second aryl group is fused with an aryl or cycloalkyl group.
33. The method of any one of the preceding clauses, wherein the contacting is performed using 1,2-dichloroethane (DCE) as a solvent.
34. The method of any one of the preceding clauses, wherein the concentration of the first compound during the contacting is 0.1 M.
35. The method of any one of the preceding clauses, wherein the contacting involves a temperature of 120° C. or less.
36. The method of any one of the preceding clauses, wherein the contacting is performed for 10 hours or less.
37. The method of any one of the preceding clauses, wherein the mole ratio of the acid catalyst to first compound is 5:100 or less.
38. The method of any one of the preceding clauses, wherein the mole ratio of the first compound to the second compound ranges from 1:1 to 1:10.
39. The method of any one of the preceding clauses, wherein the ratio of the alpha hydroarylation product to a beta hydroarylation product is 10:1 or greater, wherein the beta hydroarylation product has a carbon-carbon bond between the carbon beta to the first aryl group and a carbon of the second aryl group.
40. The method of any one of the preceding clauses, wherein a substituent of the second aryl group is located para to the carbon involved in the formed carbon-carbon bond.
41. The method of any one of the preceding clauses, wherein the method generates a yield of the product of 10% or more by mass.
42. The method of clause 41, wherein the yield is 50% or more.
43. The method of any one of the preceding clauses, wherein the ratio of the mass of the product to the combined mass of all side products is 1:1 or more.
44. The method of clause 43, wherein the ratio of the mass of the product to the combined mass of all side products is 10:1 or more.
45. The method of any one of the preceding clauses, wherein the ratio of the mass of the product to the combined mass of all dimerization side product formed from the dimerization of two first compounds is 5:1 or more.
46. The method of any one of the preceding clauses, wherein the method generates 1% or less by mass of a dimerization side product formed from the dimerization of two first compounds.
47. The method of any one of the preceding clauses, wherein the method generates 1% or less by mass of a polymerization side product.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof.

Additionally, it is intended that such equivalents include both currently known equivalents and equivalents developed in the future, i.e., any elements developed that perform the same function, regardless of structure. Moreover, nothing disclosed herein is intended to be dedicated to the public regardless of whether such disclosure is explicitly recited in the claims.

The scope of the present invention, therefore, is not intended to be limited to the exemplary embodiments shown and described herein. Rather, the scope and spirit of present invention is embodied by the appended claims. In the claims, 35 U.S.C. § 112(f) or 35 U.S.C. § 112(6) is expressly defined as being invoked for a limitation in the claim only when the exact phrase “means for” or the exact phrase “step for” is recited at the beginning of such limitation in the claim; if such exact phrase is not used in a limitation in the claim, then 35 U.S.C. § 112 (f) or 35 U.S.C. § 112(6) is not invoked.

1. A method of forming a carbon-carbon bond between a first compound and a second compound, comprising:
contacting the first compound with the second compound in the presence of an acid catalyst,
wherein the first compound comprises an electron-deficient first aryl group and a carbon-carbon double bond that are π-conjugated to one another, wherein the carbon-carbon double bond connects a carbon alpha to the first aryl group and a carbon beta to the first aryl group,
wherein the second compound comprises a second aryl group,
such that an alpha hydroarylation product is formed with a carbon-carbon bond between the carbon alpha to the first aryl group and a carbon of the second aryl group.

2. The method of claim 1, wherein the acid catalyst is a Brønsted acid.

3. The method of claim 2, wherein a conjugate base of the Brønsted acid is a non-coordinating anion.

4. The method of claim 3, wherein the Brønsted acid is trifluoromethanesulfonimide (Tf₂NH).

5. The method of claim 1, wherein the acid catalyst is a salt of a Brønsted acid.

6. The method of claim 5, wherein the acid catalyst comprises a non-coordinating cation.

7. The method of claim 6, wherein the non-coordinating cation is trityl (Ph₃C⁺), trimethylsilyl (Me₃Si⁺), or a derivative thereof.

8. The method of claim 7, wherein the non-coordinating cation is selected from the group consisting of:

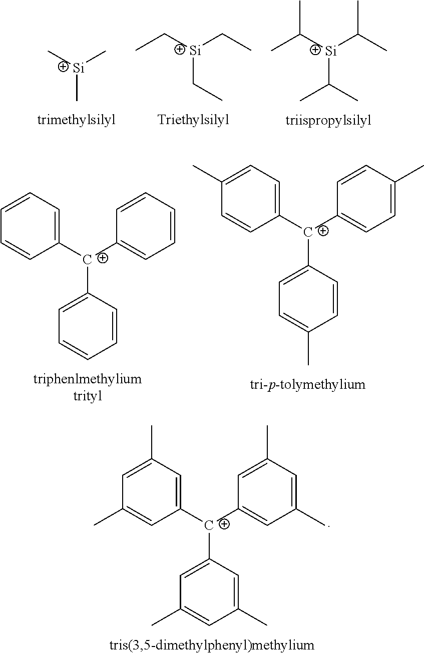

9. The method of claim 1, wherein the acid catalyst comprises a non-coordinating anion.

10. The method of claim 9, wherein the non-coordinating anion is less coordinating than triflate.

11. The method of claim 10, wherein the non-coordinating anion has the formula [(C₆X₅)₄B]⁻, wherein each X is independently selected from fluorine, hydrogen and trifluoromethyl.

12. The method of claim 11, wherein the non-coordinating anion has a formula selected from the group consisting of:

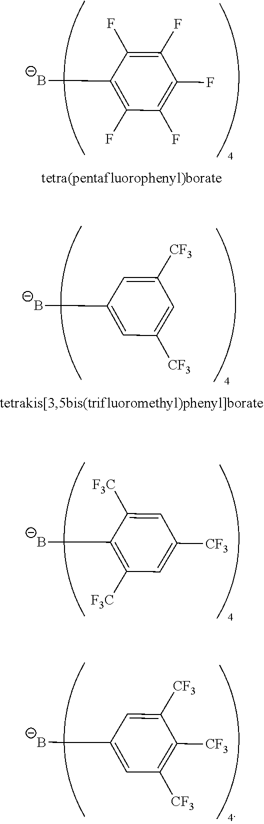

13. The method of claim 12, wherein the non-coordinating anion is tetra(pentafluorophenyl)borate ((C₆F₅)₄B⁻) or tetrakis[3,5-bis(trifluoromethyl)phenyl]borate ({3,5-(CF₃)₂C₆H₃}₄B⁻).

14. The method of claim 13, wherein the acid catalyst is triphenylmethyl tetra(pentafluorophenyl)borate ([Ph₃C]+[(C₆F₅)₄B]⁻), trimethylsilyl tetra(pentafluorophenyl)borate ([Me₃Si]+[(C₆F₅)₄B]⁻), triphenylmethyl tetrakis[3,5-bis(trifluoromethyl)phenyl]borate anion ([Ph₃C]+[{3,5-(CF₃)₂C₆H₃}₄B]⁻), or trimethylsilyl tetrakis[3,5-bis(trifluoromethyl)phenyl]borate anion ([Me₃Si]+[{3,5-(CF₃)₂C₆H₃}₄B]⁻).

15. The method of claim 14, wherein the acid catalyst is triphenylmethyl tetra(pentafluorophenyl)borate ([Ph₃C]+[(C₆F₅)₄B]⁻).

16. The method of claim 1, wherein the first aryl group is substituted with an electron-withdrawing group selected from: halogen, haloalkyl, cyano, nitro, nitroso, ammonium, sulfonyl, phosphoryl, acyl, and amide.

17. The method of claim 16, wherein the first aryl group is substituted with a haloalkyl.

18-19. (canceled)

20. The method of claim 1, wherein the carbon alpha to the first aryl ring has a carbon-carbon double bond to the carbon beta to the first aryl group, a single bond the first aryl ring, and a carbon-hydrogen bond.

21. The method of claim 1, wherein the carbon alpha to the first aryl ring has a carbon-carbon double bond to the carbon beta to the first aryl group, a single bond the first aryl ring, and another bond to a non-hydrogen group, wherein the method is a method of generating a quaternary carbon.

22-32. (canceled)

33. The method of claim 1, wherein the contacting is performed using 1,2-dichloroethane (DCE) as a solvent.

34-47. (canceled)
